(19) United States
(12) Patent Application Publication
(10) Pub. No.: US 2012/0039522 A1
(43) Pub. Date: Feb. 16, 2012

(54) MASK INSPECTION APPARATUS AND METHOD

(75) Inventors: Peter Dirksen, Valkenswaard (NL); Thomas Steffen, Eindhoven (NL)

(73) Assignee: KONINKLIJKE PHILIPS ELECTRONIC, N.V., EINDHOVEN (NL)

(21) Appl. No.: 10/597,615

(22) PCT Filed: Feb. 2, 2005
(86) PCT No.: PCT/IB2005/050435

§ 371 Date: Sep. 9, 2008

(30) Foreign Application Priority Data
Feb. 5, 2004 (EP) 04100432.6

(51) Int. Cl. G06K 9/00

(52) U.S. Cl. 382/144

(57) ABSTRACT

Apparatus for optical inspection of an object, comprising: an optical imaging system (5) for generating an actual image of the real object, a calculation unit (12) for calculating an estimated image of an object of desired shape in respect of a known aberration coefficient of the optical imaging system, an image analysis unit (13) for detecting differences between the actual image and the image calculated by the calculation unit (12).

The invention relates to optical inspections of objects, especially of masks.

U.S. Pat. No. 6,548,312 B1 discloses a method for designing a mask for a lithographic projection system. In order to inhibit or prevent a pattern abnormality such as the deformation or misalignment of a pattern of a semiconductor-integrated circuit device, a light intensity is calculated based on the pattern data DBP of a mask and the aberration data DBL of a lens of a pattern exposure device. Then the results of the light intensity calculation is compared with the results of the light intensity calculated on condition that the lens of the pattern exposure device has no aberration. Then a pattern data exceeding an allowable level, of the pattern data of the mask, is corrected according to the amount of correction calculated on the basis of the results of the comparison such that the pattern data does not exceed the allowable level. The mask is manufactured by using the mask making data DBM after the correction and is then mounted on the pattern exposure device to transfer a predetermined pattern to a semiconductor wafer.

By this method the mask is manufactured for use in the same pattern exposure device.

The structures of masks may be very small e.g. below 1 μm and may even be sub-wavelength, i.e. the dimensions of a feature approach or are smaller than the wavelength of the illumination source. For example such masks are used in the microlithography and for the production of DVDs called a master for a replication process. The way of producing very small-structured devices makes it difficult to characterize the structures of the needed masks and masks used.

Optical inspection is a method in which an object is imaged in order to investigate whether it has—within certain margins—the designed dimensions of the object, i.e. the ideal shape and transmission or reflection properties. This is particularly relevant to what are called phase shift masks and to masks used in reflection such as used in extreme UV lithography. Known apparatus for optical inspection include optical or electron microscopes. In the known method for optical inspection the image is compared to the ideal shape of the object. Deviations between the image and the ideal shape are usually attributed to imperfection of the object.

Optical inspection may include inspection by visible, ultraviolet light, DUV and EUV radiation with typical wavelength of 600, 365 (I-line), 248 (DUV), 193 and for EUV 13 nanometer wavelength. Alternatively, there exist inspection tools that use charged particles such as electrons. It is a disadvantage of the known apparatus and the known method that deviations between the image and the ideal shape of the object being inspected may result from other causes than imperfections of the object. In this case an object having—within the certain margins—the ideal shape may be rejected, because its image deviates too much from the ideal shape, named false error or an object not having the designed dimensions may be accepted because its image does not deviate from the ideal shape, named false pass.

Note that EUV masks are reflection masks and that such a microscope will be used in a reflection mode instead of a transmission mode.

It is an object of the invention to provide an apparatus and method for optical inspection of an object, wherein the recognition of deviation of the desired object and the real object is improved.

It is an object of the invention to provide an apparatus and a method for optical inspection, which allows for a more reliable inspection of the object, i.e. the number of false errors and false passes is reduced.

The object of the invention is achieved by providing an apparatus for optical inspection of an object, comprising an optical imaging system for generating an actual image of the real object. An estimated image of the object of desired shape is calculated by a calculation unit. The aberration coefficients of the optical imaging system are at least partly known and included in the calculation of the estimated image. The apparatus comprises an image analysis unit for detecting differences between the actual image and the image calculated by the calculation unit. The method for optical inspection of an actual object, in the following the actual object is also referred to as real object, comprises the steps of:

providing an optical imaging system having an aberration which is at least approximately known,
generating an actual image of the real object by using the optical imaging system,
calculating a desired image of the ideal object taking into account the measured aberration of the optical imaging system,
detecting differences between the actual image and a desired image.

The step of determining the aberration coefficient can be executed by another party.

In a further embodiment of the invention the actual image is generated when the object is approximately in a focal plane of the imaging system.

In a further embodiment of the invention the actual image is generated when the object is in a non-focal plane of the imaging system.

A further embodiment of the invention comprises the steps of generating the actual image comprises the sub-steps of:
generating a first actual image when the object is in a first plane, and
generating a second actual image when the object is in a second plane, different from the first plane,
the step of calculating the desired image comprises the sub-steps of:
   computing a first desired image for the object in the first plane, and
   computing a second desired image for the object in the second plane,
   and the step of detecting differences between the actual image and the desired image comprises the sub-steps of:
      detecting differences between the first actual image and the first desired image, and
      detecting differences between the second actual image and the second desired image.

In a further embodiment of the invention the actual image is generated when the object is approximately in a focal plane of the imaging system.

A further embodiment of the invention comprises the steps of generating the actual image comprises the sub-steps of:

generating a first actual image when the object is in a first plane, and

generating a second actual image when the object is in a second plane, different from the first plane,

the step of calculating the desired image comprises the sub-steps of:

computing a first desired image for the object in the first plane, and

computing a second desired image for the object in the second plane, and the step of detecting differences between the actual image and the desired image comprises the sub-steps of:

detecting differences between the first actual image and the first desired image, and

detecting differences between the second actual image and the second desired image.

In a further object of the invention the images of the object are taken in a lot of different planes and the corresponding ideal images are calculated by the calculation unit. The image taken of the object is compared with the corresponding calculated image of the object. The differences between the real image and the calculated image are detected. The decision whether the object has the desired shape within predetermined margins is made on the basis of the detected differences.

In a further embodiment of the invention images are taken below and above the focal plane.

In a further embodiment of the invention the aberration of the optical imaging system is determined in predetermined periods, for example during a preventive maintenance, and/or prior to special events. A special event is for example the initialization of the imaging system, before a recording or after a recording. This is only a small list of special events.

A further object of the invention is a mask comprising IC-Circuit-structured areas and a sufficiently small structure, which is suitable for determination of the aberration of an optical imaging system. By sufficiently small we mean a structure having a diameter of the order of λ/(2* NA), with λ the illumination wavelength and NA the numerical aperture of the objective lens of the inspection tool.

In a further embodiment the mask comprises a pattern recognition structure. The pattern recognition structure has a relatively large size and is therefore easy to find on the mask. Although the presence of a pattern recognition structure is not essential, it helps find the position of the image of the small structure. The pattern recognition structure is located at a predefined distance from the small structure, for example at a 50 micron distance.

The foregoing summary, as well as the following detailed description of embodiments of the invention, will be better understood when read in conjunction with the appended drawings. For the purpose of illustrating the invention, the drawings show embodiments, which are presently preferred. It should be understood, however, that the invention is not limited to these embodiments. In the drawings:

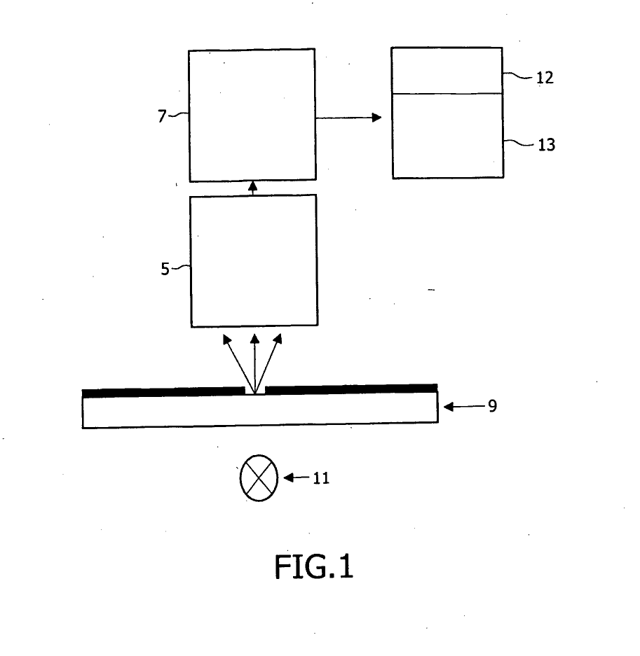

FIG. 1 shows a system for optical inspection of objects,

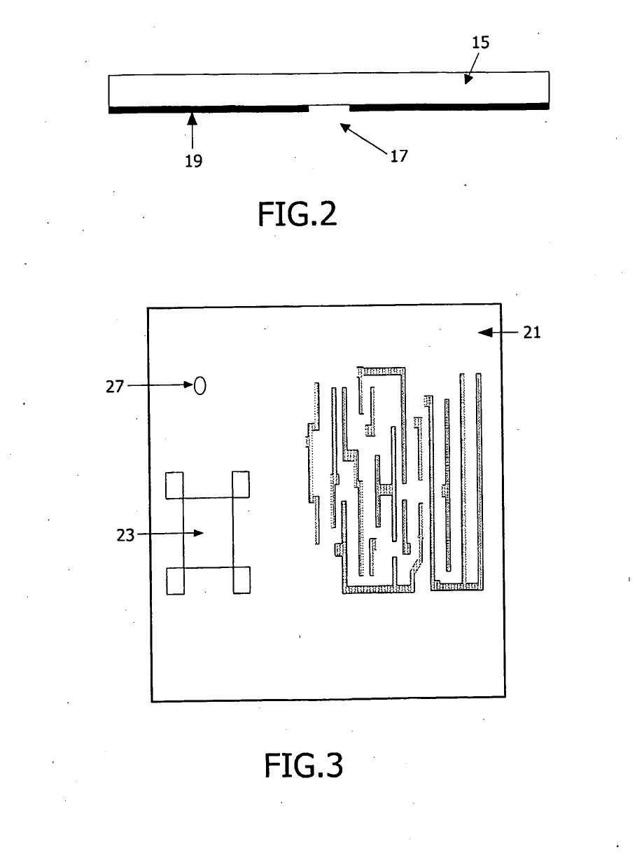

FIG. 2 shows a mask in sectional view,

FIG. 3 shows a mask in top view,

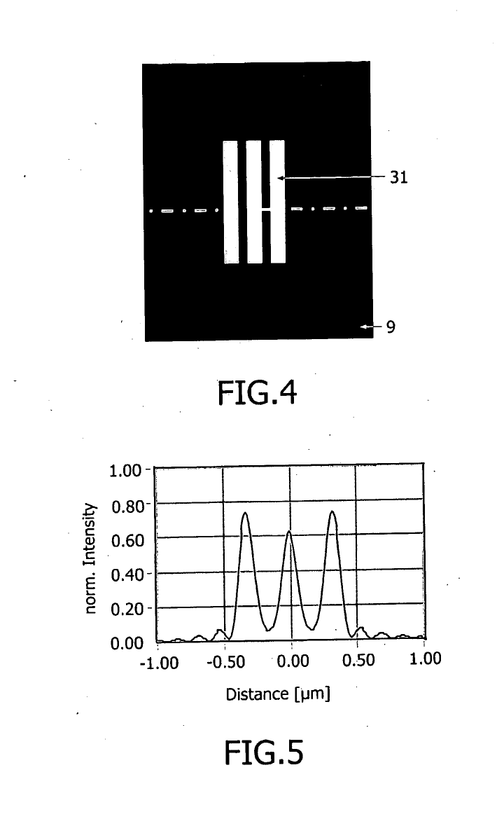

FIG. 4 shows a mask with line-structure in top view,

FIG. 5-8 give illustrations of the image in the direction of one line.

A system for optical mask inspection 1 is schematically illustrated in FIG. 1. This system comprises a light source 11, an imaging system 5 and a unit for recording the images of the object. In this case a CCD-camera 7 is used as a recoding unit and the object 8 is a mask 9. The mask 9 comprises a transparent substrate 15 and an attenuating layer 19 in respect of the emitted radiation of the light source 11.

Layer 19 may also be a partially transparent layer with a transmission of, for example, 10%, as is the case with what are called attenuated phase shifting masks. Layer 19 may also be a fully transparent layer as is the case for a phase shifting mask. In the latter case layer 19 is visible as the optical phase of the transmitted light is changed, for example by 180 degrees. Layer 19 may be absent if the substrate 15 contains etched structures. Layer 19 may also be opaque, this is for example the case if layer 19 is a chrome layer, typically of a thickness of 100 nanometer. Finally, the combination of an etched, structured substrate 15 with a (partially) transparent layer 19 exists. For the sake of simplicity we call layer 19 opaque.

The opaque layer is structured. This structure is the mask pattern. Only the mask pattern 21 can be imaged by the imaging system 5. The CCD camera 7 detects the observed image of the mask. This detected image of the mask 20 is the observed image of the mask or mask pattern respectively. Data of the detected real image are transferred to the analyzing unit. These data are compared with data of a desired image of an ideally structured mask. The calculation unit 12 generates the data of the desired image in respect of the aberration coefficient of the optical imaging system. The calculation unit determines the differences between the desired image and the real image of the mask. Acceptable are differences, which are nearly constant over the whole image.

In some cases it may be necessary to norm the intensity of the real image and the desired image in a way that the average intensity of the real image and the desired image is the same.

There is:

The mask design: an electronic data file, for example in the what is called GDS2-format. This will be used to calculate the desired image

Real mask: the true shapes of the patterns on the mask, etch depth, etc as fabricated

Observed image by the microscope, including the aberrations of the optical system

The desired image: image of the mask design as would be seen using an imaging system having the known aberrations.

In FIG. 2 a mask in sectional view is shown. The opaque layer 19 of the mask has a hole 17.

In FIG. 3 the mask is shown in top view. This mask comprises a small hole 27 and a recognition pattern 23 and an IC-circuit 21. Thereby the recognition pattern should be filled and only the contours are drawn. The illustrations of these structures are of principle character. The small hole is used for determination of the aberration coefficient of the imaging system 5. The recognition pattern 23 helps to find the position of the small hole 27. It is not necessary to have these two structures 23, 27 on every mask. In this example the IC-circuit structure 21 and the small hole 27 and the recognition structure 23 are arranged on the same mask. Preferably the recognition structure 23 and the small hole 27 are located just outside of the image field of a stepper, or in the what are called scribe lane areas, or in areas that do not impact the functionality of the IC device. So, these structures 23, 27 are separated from the structure of the IC-circuit 21. It is also possible to integrate the small hole 27 into the IC-circuit 21. It is also possible to use a suitable part of the IC-circuit structure 21, preferably having both horizontal and vertical features, as the recognition structure 27.

In FIG. 4 a mask with a line structure 31 is shown in top view. A dash-and-dot line 33 is shown. In drawings 5 to 8 measurements taken along this line 33 are displayed. In the following the method of mask inspection is described in more detail.

The errors in the mask inspection and in the recognition of mask defects are at least partly caused by imperfection in the optical system 5 used for inspection. The lenses used have aberrations such as wavefront aberrations, geometrical and/or chromatic aberrations, which lead to imperfect images, i.e. the image produced by the optical imaging system 5 differs from the actual object. In general a pupil function A.exp(I*phi) can be defined for the optical system with possible non-constant transmission amplitude A as disclosed in “Assessment of an extended Nijboer-Zernike approach for the computation of the optical point spread functions” J. Braat, P. Dierksen, A. Janssen, Opt. Soc. Am. A/Vol. 19, No. 5/ May 2002, p. 858, which is hereby incorporated by reference. It is possible to characterize these aberrations by so-called Zernike polynomials. We use the well-known Fringe Zemike convention.

When inspecting the object, deviations between the image and the ideal shape of the object being inspected at least partly result from aberrations of the lenses of the optical imaging system 5.

To determine and characterize these aberrations and the aberration coefficient of the optical imaging system, different methods are known. In WO 03/56392 A a method for determination of the aberration of an optical imaging system is described. This application is hereby incorporated by reference.

At least some of the aberration coefficients of the imaging system are known. The known aberration coefficients are used, to calculate how the desired image would look like, i.e. the image of an object having the desired shape generated by this optical imaging system 5 having these aberration coefficients. This desired image is then used to detect differences between the actual image and the desired image. The detection of the differences takes place in the analyzing unit 13. Because the desired image and not the ideal shape of the object is used for the optical inspection, deviations due to the aberration of the optical imaging system 5 lead to a smaller number of false error or false pass. The result is that is that the mask inspection is more reliable.

The desired image may be calculated as follows:

The apparatus and method according to the invention may be used when the accuracy of the optical inspection is close to the resolution limit of the optical imaging system, i.e. when the allowed error in the optical inspection is e.g. below the optical resolution.

In particular the mask inspection, where a low coherence value or pupil fill ratio of sigma <0.4 is used is especially vulnerable to aberrations. Such a setting may be used, in the inspection of phase shifting mask for example.

Further a deconvolution algorithm could be used to remove effects of defocus, aberrations and even sharpen the image. This may gain another 30% resolution.

This apparatus and method for optical inspection is for masks comprising very small structures. The apparatus and the method according to the invention may be used for the inspection of lithography masks. Such a mask may be a phase shift mask. For microlithograhy systems light of 193 nm is used, masks of structures of 500 nm and below are used. It can also be used for inspection of masks for DVD production.

The invention is not limited to inspection of masks for lithography, but may be used for the inspection of other objects as well.

For detecting differences between the actual image, and a desired image the difference in respect of intensity between the actual image and the desired image may be calculated. Preferably, the intensity, especially brightness and/or contrast, of one of these two images is scaled prior to determining the difference. and in order to compensate differences between the two images in respect of intensity.

In a further step correlated positions of the real image and the desired image have to be determined.

In general the desired image and the actual image may be translated in a plane parallel to the optical axis because the fields of view do not perfectly coincide. The two images may be mutually shifted to compensate this. The actual image taken at a number of defocus positions (e.g. 3) may be compared with the desired image at the corresponding defocus positions and a common ‘origin’ (Xo,Yo,Zo) may be determined. A “least square fit” or correlation algorithm may be used to overlay the two images. This involves the approximation of small errors in the object. After the best match (X,Y,Z) is found, the differences are calculated.

The aberration coefficient taken into account when calculating the desired image may comprise one or more of the following aberration coefficients:

Optical microscope: low-order wave front aberrations, i.e. spherical, coma, astigmatism and threefold.

Optical tools with inspection wavelength of 365-157 nm usually use a source that has a small optical bandwidth. In the future also EUV tool having an inspection wavelength of 13 nm have to use a narrow band source.

For SEM chromatic aberrations and spherical aberrations (Cs,Cc,) should be taken into account when calculating the desired image. In some cases it is useful to take also C5, fifth-order aberration, into account.

When the actual image is generated with the object approximately in the focal plane of the imaging system, the differences between the actual image and the desired image are mainly due to distortion of the amplitude of the light used for imaging. The focal plane is the plane where a sharp image is generated.

When the actual image is generated with the object is in a plane different from the focal plane of the imaging system, the difference between the actual image and the desired image mainly being due to distortion of the amplitude of the light used for imaging.

Preferably equally spaced defocus values are used, symmetrically positioned around best focus f=0. The focus position is the position where a sharp image of the object (mask) is produced. The focus increments are a fraction of λ/NA2: for example −λ/2Na2, 0 , +λ/2Na2. Number of focus values may also be 5 or even 11. More focus values result in a more accurate characterization of the optical system, but three is probably the minimum. The differences between the actual image and the desired image are mainly due to aberrations of the imaging system that cause a phase of transmission error. This is for instance relevant for the inspection of what are called binary and phase shift lithography masks used for IC-production.

When two actual images with the object in two respective planes are generated, two desired images for the object in these two planes may be calculated from the ideal shape, the aberration coefficient and from the position of the two planes. The differences between the respective actual and desired images may then be detected.

When three actual images with the objects in three respective planes are generated, three desired images of the object in these three planes may be calculated on the basis of the ideal shape; the aberration coefficient and the position of the three planes. The differences between the respective actual and desired images may then be detected.

In the latter case it is advantageous if the first plane is a focal plane of the imaging system, the second plane is above the focal plane and the third plane is below the focal plane.

The aberration coefficient may change as time progresses, for example defocus due to drift of the optical system or due to a lens-aging process. In this case a first value of the aberration coefficient may be determined before a first actual image is generated and a second value of the aberration coefficient may be determined before a second actual image is generated. The first actual image and the second actual image may be generated from the same object or from two different objects. A first desired image may be calculated from the first value of the aberration coefficient and the desired shape of the respective object, and a second desired image may be calculated from the second value of the aberration coefficient.

This method may also be used to inspect a pre-manufactured semiconductor device. An area to be inspected may include a metal line. The inspection may comprise determining a line width of the metal line.

In FIGS. 5 to 8 the sectional views along the dash-and-doff line of FIG. 4 of different images of the mask are shown in FIG. 4. The mask of FIG. 4 has a three bar structure. The bars are arranged in equal distances.

In FIG. 5 the ideal image of a mask having the ideal shape is shown, wherein the optical imaging system 5 has no aberration. Each of the three bars has a line width of 150 nm. The wavelength is λ=193 nm, the numerical aperture is NA=0.63. The mask will pass the inspection.

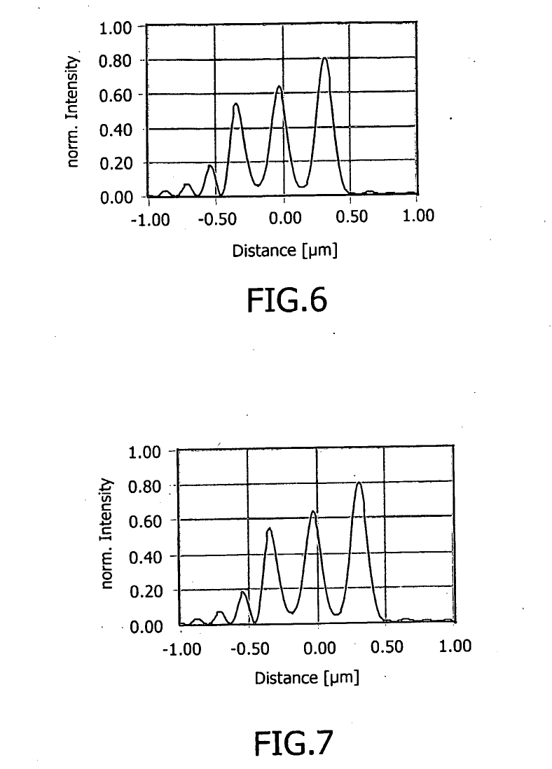

In FIG. 6 a sectional view of the real image is shown, wherein the mask has the ideal shape. The optical imaging system has X-coma, which could be described by the Zernike polynomial Z7, Fringe Zernike convention. The real image of FIG. 6 is quite different from the image shown in FIG. 5. Therefore, this mask would be rejected if the aberrations were not accounted for, leading to a false error. In contrast to this, according to the invention the desired image is calculated from the ideal shape of the mask and the aberration. The desired image in this case is identical to the real image of FIG. 6 and the false error is avoided. The comparison of the real image with the desired image results in that the inspected mask passes the inspection. The known aberration coefficient Z7 of the coma of the optical imaging system 5 was used for calculating the desired image.

Z7=(3r³−2r)cosφ

In FIG. 7 a sectional view of a mask with line width error is shown, wherein the coma Z7=0 of the optical inspection system 5. The line width of the bars is 130 nm, 150 nm, 170 nm. With the method and the inspection apparatus described above the inspected mask fails the optical inspection.

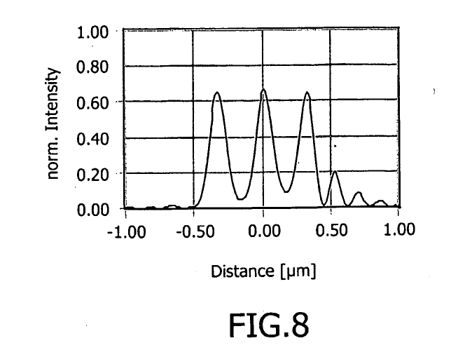

In FIG. 8 the sectional view of an image of a real mask with line width error is shown , wherein the optical system has Z7 aberration (X-coma) of −120 mwaves. The line width of the bars is 130 nm, 150 nm, 170 nm. The image is symmetrical and seems to indicate a good mask, despite the line width error. This would lead to a false pass. In contrast to this, according to the invention the real image is compared to the desired image, shown in FIG. 6. These two images are quite different. This mask does not pass the optical inspection, thus avoiding the false pass.

So it is possible to recognize the line width error of the real object or mask in comparison with the desired image in respect of coma. In a similar way spherical aberration Z9, astigmatism Z5 or Z6 or three foil aberrations Z11 may result in line width errors.

This system and method described are not limited to a system used in transmission, they can also be used in a system working in a reflection mode. In reflection mode the light source and objective lens are on the same side of the mask.

Also the usable optical imaging system is not limited to the optical system described above. Also another imaging system e.g. an immersion system may be used without leaving the scope of the invention. The imaging system may be using EUV radiation or soft x-ray radiation. The wavelength may be e.g. 13 nm.

### LIST OF REFERENCES

1 System for mask inspection
3 Microscope
5 optical imaging system
7 CCD camera optical camera for detecting the transmitted or reflected light such as a CCD camera.
8 object
9 mask/reticle
11 light source
12 calculation unit
13 analyzing unit
15 transparent material/substrate
17 hole
19 opaque material
21 IC-circuit
23 pattern recognition structure
25 structure for aberration detection
27 small hole
29
31 line structure
33 dash-and-dot line 35

1. Apparatus for optical inspection (1) of an object (8), comprising:
an optical imaging system (5) for generating an actual image of the actual object (8),
a recording unit (7) for recording the actual image of the actual object,
a calculation unit (12) for calculating an estimated image of an object of desired shape in respect of a known aberration coefficient of the optical imaging system (5), an image analysis unit (13) for detecting differences between the actual image and the image calculated by the calculation unit (12).

2. Method for optical inspection of an object, comprising the steps of:
generating an actual image of the actual object (8) by using an optical imaging system (5), wherein the aberration of the optical imaging system is known
calculating a desired image of the desired object in respect of the determined
aberration of the optical imaging system (5),
detecting differences between the actual image and a desired image.

3. Method as claimed in claim 2, wherein the aberration of the optical system is determined.

4. Method as claimed in claim 2, wherein the actual image is generated when the object (8) is approximately in a focal plane of the imaging system.

5. Method as claimed in claim 2, wherein the actual image is generated when the object (8) is in a non-focal plane of the imaging system.

6. Method as claimed in claim 2, wherein the step of generating the actual image comprises the sub-steps of:
generating a first actual image when the object is in a first plane, and
generating a second actual image when the object is in a second plane, different from the first plane,
the step of calculating the desired image comprises the sub-steps of:
calculating a first desired image for the object in the first plane, and
calculating a second desired image for the object in the second plane, and the step of detecting differences between the actual image and the desired image comprising the sub-steps of:
detecting differences between the first actual image and the first desired image, and
detecting differences between the second actual image and the second desired image.

7. Method as claimed in claim 5, wherein the step of generating the actual image further comprises the sub-step of:
generating a further actual image when the object is in at least one further plane different from the first plane and the second plane,
the step of calculating the desired image further comprising the sub-step of:
calculating a further desired image when the object (8) is in at least a further plane,
and the step of detecting differences between the actual image and the desired image further comprising the sub-step of:
detecting differences between the assigned further actual image and the further desired image.

8. Method as claimed in claim 6, wherein the first plane is a focal plane of the imaging system, the second plane is above the focal plane and the further plane is below the focal plane.

9. Method as claimed in claim 2, further comprising the step of:
determining the aberration in predetermined time periods.

10. Method as claimed in claim 2, further comprising the step of:
determining the aberration behind the startup of the optical imaging apparatus (1).

11. Method as claimed in claim 2, wherein the step of determining the aberration
comprises the sub-steps of:
determining a first aberration before the optical image is generated,
determining a second aberration after the optical image is generated,
the desired image being calculated by taking into account the first and second determined aberration.

12. Method as claimed in claim 2, wherein the object is a lithography mask (9).

13. Method as claimed in a claim 2, wherein the object is a pre-manufactured semiconductor device.

14. Method as claimed in claim 2, wherein the optical imaging system (5) is an optical microscope, especially an optical immersions microscope or an EUV microscope.

15. Method as claimed in claim 2, wherein the optical imaging system is an electron microscope.

16. Method as claimed in claim 2, further comprising the step of identifying an area of error from the detected difference between the actual image and a desired image.

17. Method as claimed in claim 16, further comprising the step of inspecting the area of error by a further inspection method.

18. Method of manufacturing an object, comprising the steps of:
manufacturing the object,
inspecting the object by a method as claimed in claim 2,
adjusting the manufacturing of the object in respect of the desired object,
manufacturing another object.

19. Mask (9) comprising IC-Circuit structured areas (21) and an infinitesimally small structure (25), which is suitable for determination of the aberration of an optical imaging system (5) of claim 1.

20. Mask as claimed in claim 19, wherein the mask comprises a recognition structure (23).

21. Mask as claimed in claim 19, wherein the infinitesimal structure (25) is a small hole in accordance of the resolution of the optical imaging system (5), wherein the diameter of the hole is smaller than the resolution of the optical imaging system (5).
